(19) United States
(12) Patent Application Publication
(10) Pub. No.: US 2024/0273460 A1
(43) Pub. Date: Aug. 15, 2024

(54) INFORMATION PROCESSING METHOD, INFORMATION PROCESSING APPARATUS, COMPUTER-READABLE MEDIUM, AND INSPECTION SYSTEM

(71) Applicant: NEC CORPORATION, Minato-ku, Tokyo (JP)

(72) Inventor: Akira TSUJI, Tokyo (JP)

(73) Assignee: NEC CORPORATION, Minato-ku, Tokyo (JP)

(21) Appl. No.: 18/563,528

(22) PCT Filed: May 31, 2021
(86) PCT No.: PCT/JP2021/020591

§ 371 Date: Nov. 22, 2023

(51) Int. Cl. G06Q 10/0836; G06Q 10/0631

(52) U.S. Cl. CPC G06Q 10/0836; G06Q 10/063114; G06Q 10/06314

(57) ABSTRACT

There is provided an information processing method including: acquiring information indicating a first facility to be currently inspected by an inspection apparatus (40) that performs facility inspection and information indicating a second facility to be inspected next by the inspection apparatus; and transmitting a request for delivering the inspection apparatus from the first facility to the second facility.

### TECHNICAL FIELD

The present disclosure relates to an information processing method, an information processing apparatus, a non-transitory computer-readable medium storing a program, and an inspection system.

### BACKGROUND ART

A technology for inspecting various facilities by using an inspection apparatus such as an autonomously moving robot is known (see, for example, Patent Literature 1).

### CITATION LIST

### Patent Literature

Patent Literature 1: Japanese Unexamined Patent Application Publication No. 2019-009919

### SUMMARY OF INVENTION

### Technical Problem

However, the technology described in Patent Literature 1 has a problem that, for example, in a case of inspecting facilities in different locations by using one inspection apparatus, it may not be possible to appropriately deliver the inspection apparatus.

In view of the above-described problem, an object of the present disclosure is to provide an information processing method, an information processing apparatus, a non-transitory computer-readable medium storing a program, and an inspection system that enable appropriate delivery of an inspection apparatus.

### Solution to Problem

According to a first aspect of the present disclosure, there is provided an information processing method including: acquiring information indicating a first facility to be presently inspected by an inspection apparatus that performs facility inspection and information indicating a second facility to be inspected next by the inspection apparatus; and transmitting a request for delivering the inspection apparatus from the first facility to the second facility.

According to a second aspect of the present disclosure, an information processing apparatus includes: acquisition means for acquiring information indicating a first facility to be presently inspected by an inspection apparatus that performs facility inspection and information indicating a second facility to be inspected next by the inspection apparatus; and transmission means for transmitting a request for delivering the inspection apparatus from the first facility to the second facility.

According to a third aspect of the present disclosure, there is provided a non-transitory computer-readable medium storing a program for causing an information processing apparatus to execute: acquisition processing of acquiring information indicating a first facility to be presently inspected by an inspection apparatus that performs facility inspection and information indicating a second facility to be inspected next by the inspection apparatus; and transmission processing of transmitting a request for delivering the inspection apparatus from the first facility to the second facility.

According to a fourth aspect of the present disclosure, there is provided an inspection system including an inspection apparatus and an information processing apparatus. In the inspection system, the information processing apparatus includes: acquisition means for acquiring information indicating a first facility to be presently inspected by an inspection apparatus that performs facility inspection and information indicating a second facility to be inspected next by the inspection apparatus; and transmission means for transmitting a request for delivering the inspection apparatus from the first facility to the second facility.

### Advantageous Effects of Invention

According to one aspect, it is possible to appropriately deliver the inspection apparatus.

### BRIEF DESCRIPTION OF DRAWINGS

FIG. 1 is a diagram illustrating an example of a configuration of an information processing apparatus that executes generation processing according to an example embodiment.

FIG. 2 is a diagram illustrating a configuration example of an inspection system according to an example embodiment.

FIG. 3 is a diagram illustrating an example of the configuration of the information processing apparatus that executes the generation processing according to an example embodiment.

FIG. 4 is a diagram illustrating a hardware configuration example of the information processing apparatus according to an example embodiment.

FIG. 5 is a diagram illustrating an example of a configuration of an inspection apparatus according to an example embodiment.

FIG. 6 is a flowchart illustrating an example of processing in the information processing apparatus according to an example embodiment.

FIG. 7 is a diagram illustrating an example of an inspection apparatus database (DB) according to an example embodiment.

FIG. 8 is a diagram illustrating an example of a delivery request DB according to an example embodiment.

FIG. 9 is a diagram illustrating an example of a facility DB according to an example embodiment.

### EXAMPLE EMBODIMENT

The principles of the present disclosure will be described with reference to several exemplary example embodiments. It is to be understood that these example embodiments have been described for purposes of illustration only and will aid those skilled in the art in understanding and carrying out the present disclosure without suggesting limitations on the scope of the present disclosure. The disclosure described in the present description is implemented in various methods other than those described below.

In the following description and claims, unless defined otherwise, all technical and scientific terms used in the present specification have the same meaning as commonly understood by those skilled in the art of the technical field to which the present disclosure belongs.

Hereinafter, example embodiments of the present disclosure will be described with reference to the drawings.

### First Example Embodiment

### <Configuration>

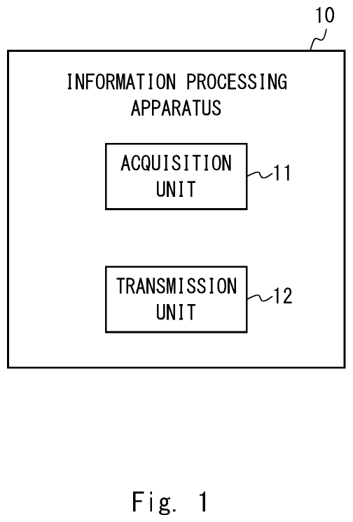

Next, a configuration of an information processing apparatus 10 according to an example embodiment will be described with reference to FIG. 1. FIG. 1 is a diagram illustrating an example of the configuration of the information processing apparatus 10 according to the example embodiment. The information processing apparatus 10 includes an acquisition unit 11 and a transmission unit 12. These units may be implemented by cooperation of one or more programs installed in the information processing apparatus 10 and hardware such as a processor 101 and a memory 102 of the information processing apparatus 10.

The acquisition unit 11 acquires various types of information from a storage unit in the information processing apparatus 10 or an external apparatus. The acquisition unit 11 acquires, for example, information indicating a first location to be presently inspected by an inspection apparatus that performs facility inspection and information indicating a second location to be inspected next by the inspection apparatus.

The transmission unit 12 transmits (outputs or records) various types of information to the storage unit in the information processing apparatus 10 or an external apparatus. For example, the transmission unit 12 transmits a request for delivering the inspection apparatus from the first location to the second location based on the information acquired by the acquisition unit 11.

### Second Example Embodiment

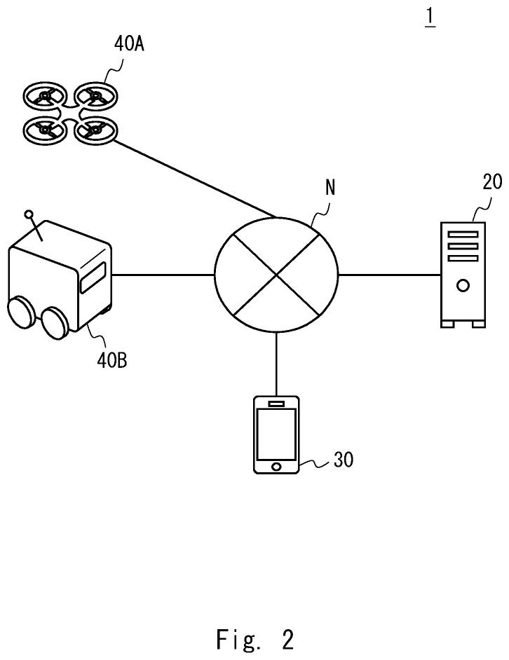

Next, a configuration of an inspection system 1 according to an example embodiment will be described with reference to FIG. 2.

### <System Configuration>

FIG. 2 is a diagram illustrating a configuration example of the inspection system 1 according to the example embodiment. In the example of FIG. 2, the inspection system 1 includes a server 20 and a courier terminal 30. The inspection system 1 includes an inspection apparatus 40A and an inspection apparatus 40B (hereinafter, also simply referred to as “inspection apparatus 40” in a case where there is no need to distinguish them). The number of servers 20, the number of courier terminals 30, and the number of inspection apparatuses 40 are not limited to those in the example of FIG. 2. At least one of the server 20, the courier terminal 30, or the inspection apparatus 40 is an example of the information processing apparatus 10.

Hereinafter, an example in which the server 20 includes the information processing apparatus 10 will be described. The processing in the information processing apparatus 10 may be executed by any one or more of the server 20, the courier terminal 30, and the inspection apparatus 40.

In the example of FIG. 2, the server 20, the courier terminal 30, and the inspection apparatus 40 are connected via a network N in a communicable manner. Examples of the network N include the Internet, a mobile communication system, a wireless local area network (LAN), short-range wireless communication such as Bluetooth Low Energy (BLE), a LAN, a bus, and the like. Examples of the mobile communication system include a fifth generation mobile communication system (5G), a fourth generation mobile communication system (4G), a third generation mobile communication system (3G), and the like.

The server 20 may be, for example, an apparatus such as a server, a cloud, a personal computer, or a smartphone. The server 20 provides various services using the inspection apparatus 40. The server 20 manages, for example, a schedule related to inspection using the inspection apparatus 40 and delivery of the inspection apparatus 40. Furthermore, for example, the server 20 causes the inspection apparatus 40 that has completed inspection in a certain facility to be delivered to a facility at another location. As a result, a plurality of facilities can be inspected by one inspection apparatus 40. Therefore, for example, the inspection cost can be reduced as compared with a case where facilities respectively operate the inspection apparatuses 40. In addition, it is possible to reduce legal problems regarding traffic or the like and battery problems as compared with a case where the inspection apparatus 40 autonomously moves between facilities.

The courier terminal 30 may be, for example, an apparatus such as a smartphone, a tablet, a personal computer, an Internet of Things (IoT) communication apparatus, or a mobile phone. The courier terminal 30 may be carried by a courier who delivers the inspection apparatus 40. The courier may be a company that operates the information processing apparatus 10, a company that operates the inspection apparatus 40, or an employee of a delivery company.

For example, the courier terminal 30 receives and displays a delivery request for the inspection apparatus 40. In addition, the courier terminal 30 transmits a notification of delivery completion or the like to the server 20 in response to an operation of the courier, for example.

The inspection apparatus 40 is an apparatus including a sensor for inspecting various facilities such as a substation, a power plant, a factory, and a chemical plant. The inspection apparatus 40 may have a function of performing inspection while autonomously moving around the facility. In this case, the inspection apparatus 40 may be, for example, an autonomously mobile robot that moves on the ground by wheels or legs. The inspection apparatus 40 may also be, for example, a drone (unmanned aerial vehicle) that moves by flight, a balloon, or the like.

### <Configuration>

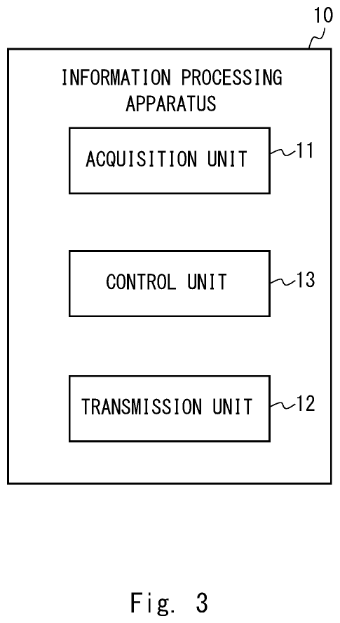

Next, a configuration of the information processing apparatus 10 according to the example embodiment will be described with reference to FIG. 3. FIG. 3 is a diagram illustrating an example of the configuration of the information processing apparatus 10 according to the example embodiment. The example of FIG. 3 is different from the example of FIG. 1 in that the information processing apparatus 10 further includes a control unit 13. The control unit 13 may be implemented by cooperation of one or more programs installed in the information processing apparatus 10 and hardware such as a processor 101 and a memory 102 of the information processing apparatus 10. The control unit 13 performs various controls in various services provided by the information processing apparatus 10.

### <Hardware Configuration>

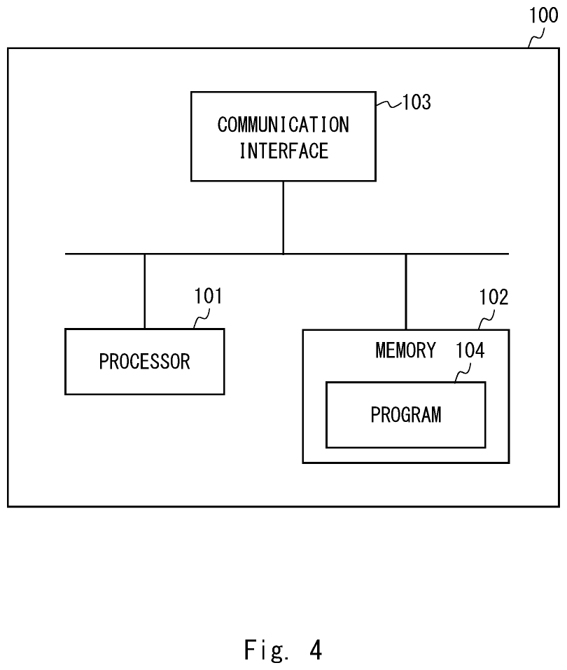

FIG. 4 is a diagram illustrating a hardware configuration example of the information processing apparatus 10 according to the example embodiment. In the example of FIG. 4, the information processing apparatus 10 (a computer 100) includes the processor 101, the memory 102, and a communication interface 103. These units may be connected by a bus or the like. The memory 102 stores at least a part of a program 104. The communication interface 103 includes an interface necessary for communication with other network elements.

When the program 104 is executed by the processor 101, the memory 102, and the like in cooperation with each other, at least a part of the processing according to the example embodiment of the present disclosure is executed by the computer 100. The memory 102 may be of any type suitable for a local technology network. The memory 102 may be a non-transitory computer-readable storage medium, as a non-limiting example. The memory 102 may also be implemented using any suitable data storage technology, such as semiconductor-based memory apparatuses, magnetic memory apparatuses and systems, optical memory apparatuses and systems, fixed memory and removable memory, and the like. Although only one memory 102 is illustrated in the computer 100, there may be several physically different memory modules in the computer 100. The processor 101 may be of any type. The processor 101 may include one or more of a general purpose computer, a special purpose computer, a microprocessor, a digital signal processor (DSP), and a processor based on a multi-core processor architecture as a non-limiting example. The computer 100 may include a plurality of processors such as application specific integrated circuit chips that are temporally dependent on a clock that synchronizes a main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, microprocessor or other computing apparatus.

The present disclosure also provides at least one computer program product tangibly stored on a non-transitory computer-readable storage medium. The computer program product includes computer-executable instructions, such as those included in a program module, and executes on an apparatus on the subject real or virtual processor to perform the processes or methods of the present disclosure. Program modules include routines, programs, libraries, objects, classes, components, data structures, and the like that execute particular tasks or implement particular abstract data types. The functionality of the program modules may be combined or divided between the program modules as desired in various example embodiments. The machine-executable instructions of the program module can be executed in a local or distributed apparatus. In a distributed apparatus, program modules can be located on both local and remote storage media.

Program code for executing the methods of the present disclosure may be written in any combination of one or more programming languages. These program codes are provided to a processor or controller of a general purpose computer, dedicated computer, or other programmable data processing apparatus. When the program code is executed by a processor or controller, the functions/acts in the flowcharts and/or the implementing block diagrams are performed. The program code executes entirely on the machine, partly on the machine, as a stand-alone software package, partly on the machine, partly on a remote machine, or entirely on the remote machine or server.

The program can be stored and supplied to the computer using various types of non-transitory computer readable media. The non-transitory computer readable media include various types of tangible storage media. Examples of the non-transitory computer readable medium include a magnetic recording medium, a magneto-optical recording medium, an optical disc medium, and a semiconductor Examples of the magnetic recording medium include a flexible disk, a memory, magnetic tape, and a hard disk drive. Examples of the magneto-optical recording medium include a magneto-optical disk. Examples of the optical disc medium include a Blu-ray disc, a compact disc (CD)-read only memory (ROM), a CD-recordable (R), and a CD-rewritable (RW). Examples of the semiconductor memory include a solid state drive, a mask ROM, a programmable ROM (PROM), an erasable PROM (EPROM), a flash ROM, and a random access memory (RAM). In addition, the program may be supplied to the computer using various types of transitory computer readable media. Examples of the transitory computer readable media include electrical signals, optical signals, and electromagnetic waves. The transitory computer-readable media can supply the programs to the computer via wired or wireless communication paths such as wires and optical fiber.

### <Inspection Apparatus 40>

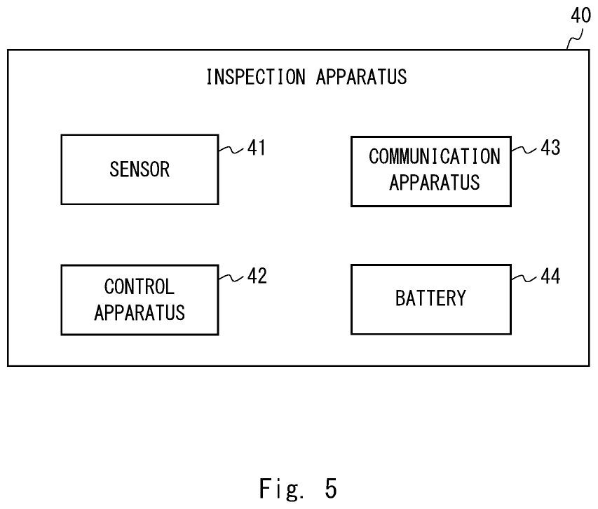

Next, an example of processing in the inspection apparatus 40 according to the example embodiment will be described with reference to FIG. 5. FIG. 5 is a diagram illustrating an example of a configuration of the inspection apparatus 40 according to the example embodiment. In the example of FIG. 5, the inspection apparatus 40 includes a sensor 41, a control apparatus 42, a communication apparatus 43, and a battery 44.

The sensor 41 measures various types of information of a facility (equipment) to be inspected. The sensor 41 may include, for example, a light detection and ranging (LiDAR) that irradiates a target object with light such as laser light and captures reflected light to measure a shape of the target object. In this case, for example, when the shape of the target object is different between the past measurement and the current measurement, the control apparatus 42 may determine that an abnormality has occurred in the target object. As a result, for example, even in a case where there is no accumulation of data regarding abnormal values, it is possible to appropriately detect abnormalities such as nesting, oil leakage, and breakage of an insulator. Furthermore, the sensor 41 may include a camera that captures an image. As a result, for example, an image of a portion whose abnormality is detected by the LiDAR or the like can be captured, and the image can be provided to an administrator or the like.

The control apparatus 42 outputs data measured using the sensor 41 to an external apparatus by using the communication apparatus 43. The control apparatus 42 may have a configuration similar to that of the computer 100 illustrated in FIG. 3. In this case, the control apparatus 42 may be, for example, a microcontroller. The battery 44 is a secondary battery (storage battery or rechargeable battery) that supplies power to each unit of the inspection apparatus 40.

### <Processing>

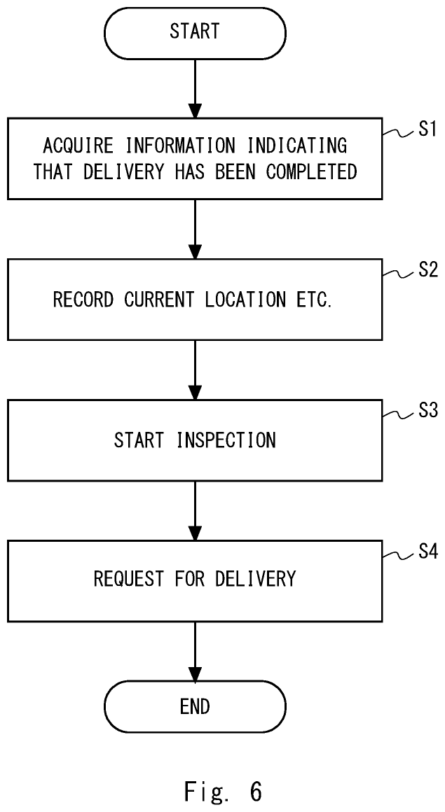

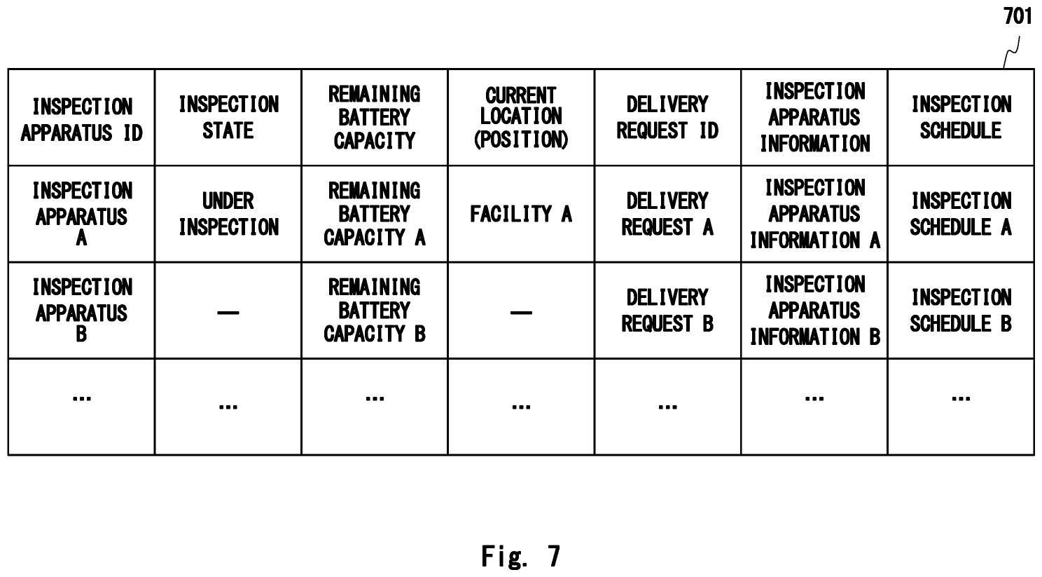

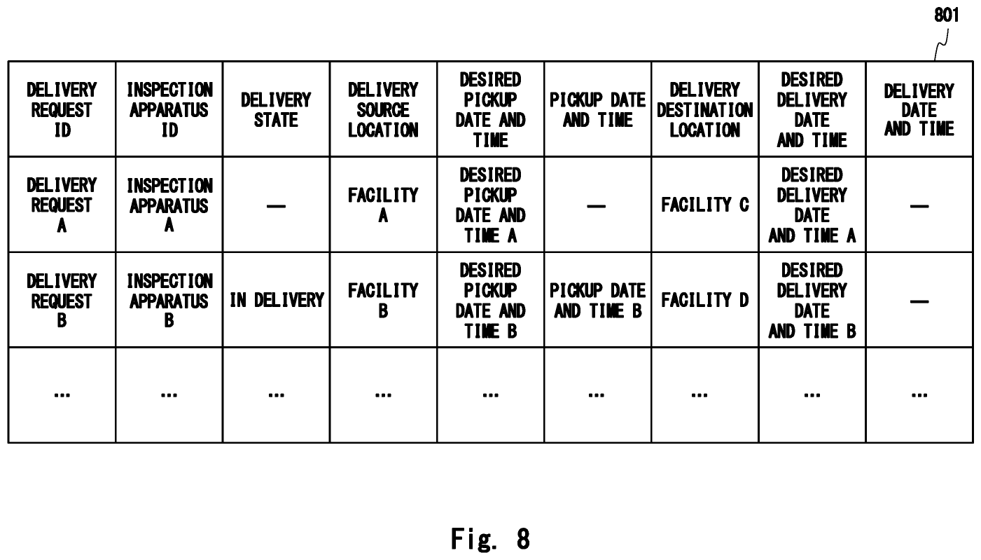

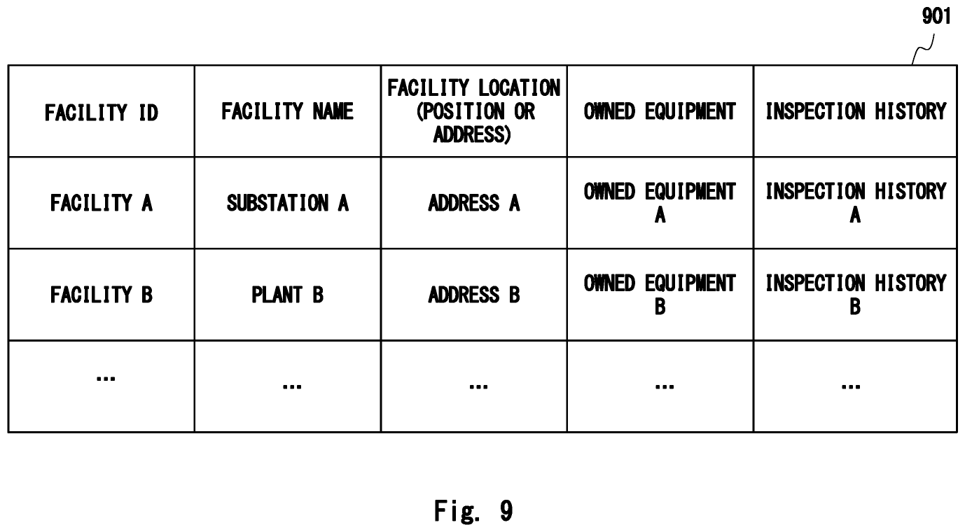

Next, an example of processing in the information processing apparatus 10 (for example, the server 20) according to the example embodiment will be described with reference to FIGS. 6 to 9. FIG. 6 is a flowchart illustrating an example of the processing in the information processing apparatus 10 according to the example embodiment. FIG. 7 is a diagram illustrating an example of an inspection apparatus database (DB) 701 according to the example embodiment. FIG. 8 is a diagram illustrating an example of a delivery request DB 801 according to the example embodiment. FIG. 9 is a diagram illustrating an example of a facility DB 901 according to the example embodiment.

The inspection apparatus 40 and the courier terminal 30 may communicate with the information processing apparatus 10 after being authenticated with an ID, a password, and the like by the information processing apparatus 10. Communication data transmitted from the inspection apparatus 40 to the information processing apparatus 10 may include information that can identify the inspection apparatus 40. In this case, the information that can identify the inspection apparatus 40 may include an inspection apparatus ID that is identification information of the inspection apparatus 40 and an ID of a communication session when the inspection apparatus 40 logs in to the information processing apparatus 10.

Similarly, communication data transmitted from the courier terminal 30 to the information processing apparatus 10 may include information that can identify the courier terminal 30. In this case, the information that can identify the courier terminal 30 may include a courier terminal ID that is identification information of the courier terminal 30 and an ID of a communication session when the courier terminal 30 logs in to the information processing apparatus 10.

In step S1, the acquisition unit 11 of the information processing apparatus 10 acquires information indicating that delivery of the inspection apparatus 40 to a facility to be presently inspected has been completed. Here, when the courier delivers the inspection apparatus 40 to the facility to be presently inspected according to the previous delivery request, the courier may operate the courier terminal 30 to transmit a notification of delivery completion to the information processing apparatus 10. The notification of delivery completion may include, for example, at least one of pieces of information such as the inspection apparatus ID that is the identification information of the inspection apparatus 40, a delivery request ID that is identification information of the delivery request, and a facility ID that is identification information of the facility to be presently inspected, the facility being a delivery destination.

Subsequently, the control unit 13 of the information processing apparatus 10 records information such as the current location of the inspection apparatus 40 (step S2). Here, for example, the information processing apparatus 10 may update information recorded in the inspection apparatus DB 701 and the delivery request DB 801 based on the notification of delivery completion received from the courier terminal 30.

In the example of FIG. 7, an inspection state, a remaining battery capacity, a current location (position), a delivery request ID, inspection apparatus information, and an inspection schedule are recorded in the inspection apparatus DB 701 in association with the inspection apparatus ID. The inspection state is information indicating a state related to inspection performed by the inspection apparatus 40. The inspection state may include, for example, “available”, “under inspection”, and “inspection completed”. The remaining battery capacity is the current remaining battery capacity of the inspection apparatus 40. A notification of the remaining battery capacity may be made by the inspection apparatus 40 at a timing such as a regular time.

The inspection apparatus information is information indicating the inspection apparatus 40. The inspection apparatus information may include, for example, information such as the type, color, size, and weight of the inspection apparatus 40, and cautions regarding delivery of the inspection apparatus 40. Examples of the type of the inspection apparatus 40 may include a drone and an autonomous mobile robot. The courier may be notified of the color, size, and weight of the inspection apparatus 40, and information regarding the cautions regarding delivery of the inspection apparatus 40 when the delivery is requested. For example, the inspection apparatus information may be registered in advance by an operator of the information processing apparatus 10 or the like.

The inspection schedule is a schedule related to inspection performed by the inspection apparatus 40. In the example of FIG. 7, identification information of facilities as next and subsequent inspection targets is recorded in the inspection schedule. For example, the inspection schedule may be registered by the operator of the information processing apparatus 10 or the like.

Furthermore, the information processing apparatus 10 may determine the inspection schedule based on the progress of inspection work performed by each inspection apparatus 40. In this case, the information processing apparatus 10 may cause the inspection apparatus 40 that is available after completion of the inspection work to be delivered to a facility to be inspected according to the type or the like of the inspection apparatus 40 and perform the inspection work. As a result, for example, even in a case where the inspection apparatus 40 scheduled to inspect a certain facility fails, the facility can be inspected using another inspection apparatus 40.

In the example of FIG. 8, the inspection apparatus ID, a delivery state, a delivery source location, a desired pickup date and time, a pickup date and time, a delivery destination location, a desired delivery date and time, and a delivery date and time are recorded in the delivery request DB 801 in association with the delivery request ID. The delivery state is information indicating a state related to delivery of the inspection apparatus 40. The delivery state may include, for example, “in delivery”, “delivery completed”, and “pickup waiting”.

In the processing of step S2, the information processing apparatus 10 updates the inspection state from “in delivery” to “ready for inspection” in the inspection apparatus DB 701, and records (updates) the identification information of the facility to be presently inspected to which the inspection apparatus 40 has been delivered to the “current location” item. Furthermore, the information processing apparatus 10 updates the delivery state from “in delivery” to “delivery completed” in the delivery request DB 801, and records the current date and time in the “delivery date and time” item.

Subsequently, the transmission unit 12 of the information processing apparatus 10 causes the inspection apparatus 40 to start inspection of the facility to be presently inspected (step S3). Here, the information processing apparatus may transmit an inspection start command and information indicating an autonomous movement route at the time of inspection and an object (equipment) to be inspected to the inspection apparatus 40. The information indicating the object to be inspected may include, for example, an image of the object. Furthermore, the information processing apparatus 10 updates the inspection state from “available” to “under inspection” in the inspection apparatus DB 701.

Subsequently, the control unit 13 and the transmission unit 12 of the information processing apparatus 10 request for delivery of the inspection apparatus 40 (step S4). Here, the control unit 13 of the information processing apparatus 10 may cause the transmission unit 12 to transmit a delivery request including information such as the inspection apparatus information, the delivery source location, the desired pickup date and time, the delivery destination location, and the desired delivery date and time to the courier terminal 30.

Furthermore, the information processing apparatus 10 updates the delivery state from “delivery completed” to “pickup waiting” in the delivery request DB 801. In addition, once a notification indicating that the inspection is completed is received from the inspection apparatus 40, the information processing apparatus 10 updates the inspection state from “under inspection” to “inspection completed” in the inspection apparatus DB 701.

The information processing apparatus 10 may determine a date and time (the desired pickup date and time) at which the inspection apparatus 40 is to be picked up at the facility to be presently inspected based on a scheduled date and time (time point) at which inspection of the facility to be presently inspected by the inspection apparatus 40 is to be completed. As a result, for example, a pickup waiting time for the inspection apparatus 40 can be reduced, so that the inspection apparatus 40 can be used more efficiently. In this case, for example, the information processing apparatus 10 may estimate a required time for the current inspection based on a history of a required time for the previous inspection of the facility to be presently inspected. In this case, for example, the information processing apparatus 10 may estimate, as the required time for the current inspection, a representative value (for example, the mean, the mode, or the median) of the required time for the previous inspection of the facility to be presently inspected.

In addition, the information processing apparatus 10 may determine the date and time when the inspection apparatus 40 is to be picked up at the facility to be presently inspected based on a scheduled date and time when charging of the inspection apparatus 40 in the facility to be presently inspected is to be completed. As a result, for example, a pickup waiting time for the inspection apparatus 40 can be reduced, so that the inspection apparatus 40 can be used more efficiently. In this case, for example, the information processing apparatus 10 may estimate a required time for the current charging based on a history of a required time for the previous charging in the facility to be presently inspected. Furthermore, the information processing apparatus 10 may acquire the estimated value of the required time for the current charging from the inspection apparatus 40. For example, once the inspection is completed, the inspection apparatus 40 may autonomously move to a charging station in the facility to be presently inspected and start charging.

In addition, the information processing apparatus 10 may determine the date and time when the inspection apparatus 40 is to be picked up at the facility to be presently inspected based on a situation of the facility to be presently inspected detected by the inspection apparatus 40. As a result, for example, a pickup waiting time for the inspection apparatus 40 can be reduced, so that the inspection apparatus 40 can be used more efficiently. In this case, the information processing apparatus 10 may determine additional inspection work in the facility to be presently inspected based on information measured by the sensor 41 of the inspection apparatus 40. Here, for example, in a case where an abnormality such as bird nesting, oil leakage, or breakage of an insulator is detected by the sensor 41, the information processing apparatus 10 may transmit an instruction for inspection work such as capturing of an image of an abnormal portion and re-measurement with higher accuracy by the sensor 41 to the inspection apparatus 40. Then, the information processing apparatus 10 may determine (update) the date and time when the inspection apparatus 40 is to be picked up at the facility to be presently inspected based on a scheduled date and time when the additional inspection work is to be completed.

Furthermore, the information processing apparatus 10 may determine a facility to be inspected next by the inspection apparatus 40 based on the situation of the facility to be presently inspected detected by the inspection apparatus 40. As a result, for example, when an abnormality such as bird nesting is detected in the facility to be presently inspected, it is possible to preferentially inspect a facility in which a similar abnormality is highly likely to occur. In this case, the information processing apparatus 10 may determine, by referring to the facility DB 901 that records information of each facility to be inspected, a facility similar to the facility to be presently inspected as the facility to be inspected next by the inspection apparatus 40 according to a content of the abnormality detected in the facility to be presently inspected.

In addition, the information processing apparatus 10 may determine the date and time when the inspection apparatus 40 is to be picked up at the facility to be presently inspected based on an estimated date and time when data transmission from the inspection apparatus 40 in the facility to be presently inspected is to be completed. As a result, for example, a pickup waiting time for the inspection apparatus 40 can be reduced, so that the inspection apparatus 40 can be used more efficiently. In this case, for example, the inspection apparatus 40 may transmit three-dimensional point cloud data measured by the LiDAR or the like to an apparatus of a center via a wireless LAN base station (access point) of the facility to be presently inspected or the like. Then, when the data is transmitted, the inspection apparatus 40 may calculate an estimated time required for completion of the data transmission based on a data size of an untransmitted portion of the data and a communication band and notify the information processing apparatus 10 of the estimated time. Then, the information processing apparatus 10 may determine (update) the date and time when the inspection apparatus 40 is to be picked up at the facility to be presently inspected based on the received estimated time and the current date and time.

Furthermore, in a case where the information processing apparatus 10 has received a predetermined notification from the inspection apparatus 40 in the facility to be presently inspected, the information processing apparatus 10 may transmit the delivery request to the courier terminal 30. In this case, for example, in the facility to be presently inspected, the inspection apparatus 40 may transmit the predetermined notification to the information processing apparatus 10 at a predetermined timing such as a timing at which the inspection is completed, a timing at which the charging of the inspection apparatus 40 is completed, or a timing at which the data transmission from the inspection apparatus 40 is completed.

In the example of FIG. 9, the facility DB 901 records a facility name, a facility location (position or address), owned equipment, and an inspection history in association with the facility ID. Information regarding the facility ID, the facility name, the facility location, and the owned equipment may be registered in advance by, for example, the operator of the like of the information processing apparatus 10 or the like. The inspection history may be recorded by the information processing apparatus 10 when inspection performed by the inspection apparatus 40 is completed. The inspection history may include, for example, information regarding the inspection apparatus ID of the inspection apparatus 40 that has performed the inspection, an inspection date and time, and an inspection result. The inspection result may include information indicating the presence or absence of an abnormality and a content of an abnormality.

Furthermore, the information processing apparatus 10 may determine a date and time of delivery to (arrival at) the facility to be inspected next by the inspection apparatus 40 based on the situation of the facility to be presently inspected detected by the inspection apparatus 40. As a result, for example, when an abnormality such as bird nesting is detected in the facility to be presently inspected, the date and time of arrival at the facility to be inspected next can be set to an earlier date and time than usual, so that the inspection can be started earlier. In this case, for example, in a case where a metal hanger or the like is mixed in a bird nest in a substation, the information processing apparatus 10 may determine the desired delivery date and time in such a way that the inspection apparatus 40 is delivered earlier than usual by paying an additional delivery charge to the courier or the like.

### Modified Example

The information processing apparatus 10 may be an apparatus included in one housing, but the information processing apparatus 10 of the present disclosure is not limited thereto. Each unit of the information processing apparatus 10 may be implemented by, for example, cloud computing including one or more computers. Furthermore, each unit of the information processing apparatus 10 may be implemented by, for example, a plurality of apparatuses among the server 20, the courier terminal 30, and the inspection apparatus 40. Such an information processing apparatus 10 is also included in an example of the “information processing apparatus” of the present disclosure.

Note that the present disclosure is not limited to the above-described example embodiments, and can be appropriately modified without departing from the gist.

Some or all of the above-described example embodiments can be described as in the following Supplementary Notes, but are not limited to the following Supplementary Notes.

### (Supplementary Note 1)

An information processing method including:
acquiring information indicating a first facility to be presently inspected by an inspection apparatus that performs facility inspection and information indicating a second facility to be inspected next by the inspection apparatus; and transmitting a request for delivering the inspection apparatus from the first facility to the second facility.

### (Supplementary Note 2)

The information processing method according to Supplementary Note 1, in which the inspection apparatus includes an autonomous mobile robot, an unmanned aerial vehicle, or a balloon.

### (Supplementary Note 3)

The information processing method according to Supplementary Note 1 or 2, further including:
determining a date and time when the inspection apparatus is to be picked up at the first facility based on a scheduled date and time when inspection of the first facility by the inspection apparatus is to be completed; and
transmitting a request for picking up the inspection apparatus at the first facility on the date and time and delivering the inspection apparatus to the second facility.

### (Supplementary Note 4)

The information processing method according to any one of Supplementary Notes 1 to 3, further including:
determining the date and time when the inspection apparatus is to be picked up at the first facility based on a scheduled date and time when charging of the inspection apparatus in the first facility is to be completed; and
transmitting a request for picking up the inspection apparatus at the first facility on the date and time and delivering the inspection apparatus to the second facility.

### (Supplementary Note 5)

The information processing method according to any one of Supplementary Notes 1 to 4, further including:
determining the date and time when the inspection apparatus is to be picked up at the first facility based on a situation of the first facility detected by the inspection apparatus; and
transmitting a request for picking up the inspection apparatus at the first facility on the date and time and delivering the inspection apparatus to the second facility.

### (Supplementary Note 6)

The information processing method according to any one of Supplementary Notes 1 to 5, further including:
determining the second facility to be inspected next by the inspection apparatus based on the situation of the first facility detected by the inspection apparatus; and
transmitting the request for delivering the inspection apparatus from the first facility to the second facility.

### (Supplementary Note 7)

The information processing method according to any one of Supplementary Notes 1 to 6, further comprising:
determining a date and time when the inspection apparatus is to be delivered to the second facility to be inspected next by the inspection apparatus based on the situation of the first facility detected by the inspection apparatus; and
transmitting the request for delivering the inspection apparatus from the first facility to the second facility.

### (Supplementary Note 8)

An information processing apparatus including:
acquisition means for acquiring information indicating a first facility to be presently inspected by an inspection apparatus that performs facility inspection and information indicating a second facility to be inspected next by the inspection apparatus; and
transmission means for transmitting a request for delivering the inspection apparatus from the first facility to the second facility.

### (Supplementary Note 9)

The information processing apparatus according to Supplementary Note 8, the inspection apparatus includes an autonomous mobile robot, an unmanned aerial vehicle, or a balloon.

### (Supplementary Note 10)

A non-transitory computer-readable medium storing a program for causing an information processing apparatus to execute:
acquisition processing of acquiring information indicating a first facility to be currently inspected by an inspection apparatus that performs facility inspection and information indicating a second facility to be inspected next by the inspection apparatus; and
transmission processing of transmitting a request for delivering the inspection apparatus from the first facility to the second facility.

### (Supplementary Note 11)

An inspection system including:
an inspection apparatus; and
an information processing apparatus,
wherein the information processing apparatus includes:
acquisition means for acquiring information indicating a first facility to be currently inspected by an inspection apparatus that performs facility inspection and information indicating a second facility to be inspected next by the inspection apparatus; and
transmission means for transmitting a request for delivering the inspection apparatus from the first facility to the second facility.

### (Supplementary Note 12)

The inspection system according to Supplementary Note 11, in which the inspection apparatus includes an autonomous mobile robot, an unmanned aerial vehicle, or a balloon.

### REFERENCE SIGNS LIST

1 INSPECTION SYSTEM
10 INFORMATION PROCESSING APPARATUS
11 ACQUISITION UNIT
12 TRANSMISSION UNIT
13 CONTROL UNIT
20 SERVER
30 COURIER TERMINAL
40 INSPECTION APPARATUS
41 SENSOR
42 CONTROL APPARATUS
43 COMMUNICATION APPARATUS
44 BATTERY

What is claimed is:

1. An information processing method comprising:
acquiring information indicating a first facility to be presently inspected by an inspection apparatus that performs facility inspection and information indicating a second facility to be inspected next by the inspection apparatus; and
transmitting a request for delivering the inspection apparatus from the first facility to the second facility.

2. The information processing method according to claim 1, wherein the inspection apparatus includes an autonomous mobile robot, an unmanned aerial vehicle, or a balloon.

3. The information processing method according to claim 1, further comprising:
determining a date and time when the inspection apparatus is to be picked up at the first facility based on a scheduled date and time when inspection of the first facility by the inspection apparatus is to be completed; and
transmitting a request for picking up the inspection apparatus at the first facility on the date and time and delivering the inspection apparatus to the second facility.

4. The information processing method according to claim 1, further comprising:
determining the date and time when the inspection apparatus is to be picked up at the first facility based on a scheduled date and time when charging of the inspection apparatus in the first facility is to be completed; and
transmitting the request for picking up the inspection apparatus at the first facility on the date and time and delivering the inspection apparatus to the second facility.

5. The information processing method according to claim 1, further comprising:
determining the date and time when the inspection apparatus is to be picked up at the first facility based on a situation of the first facility detected by the inspection apparatus; and
transmitting the request for picking up the inspection apparatus at the first facility on the date and time and delivering the inspection apparatus to the second facility.

6. The information processing method according to claim 1, further comprising:
determining the second facility to be inspected next by the inspection apparatus based on the situation of the first facility detected by the inspection apparatus; and
transmitting the request for delivering the inspection apparatus from the first facility to the second facility.

7. The information processing method according to claim 1, further comprising:
determining a date and time when the inspection apparatus is to be delivered to the second facility to be inspected next by the inspection apparatus based on the situation of the first facility detected by the inspection apparatus; and
transmitting the request for delivering the inspection apparatus from the first facility to the second facility.

8. An information processing apparatus comprising:
at least one memory storing instructions, and
at least one processor configured to execute the instructions to;
acquire information indicating a first facility to be presently inspected by an inspection apparatus that performs facility inspection and information indicating a second facility to be inspected next by the inspection apparatus; and
transmit a request for delivering the inspection apparatus from the first facility to the second facility.

9. The information processing apparatus according to claim 8, wherein the inspection apparatus includes an autonomous mobile robot, an unmanned aerial vehicle, or a balloon.

10. A non-transitory computer-readable medium storing a program for causing an information processing apparatus to execute:
acquisition processing of acquiring information indicating a first facility to be currently inspected by an inspection apparatus that performs facility inspection and information indicating a second facility to be inspected next by the inspection apparatus; and
transmission processing of transmitting a request for delivering the inspection apparatus from the first facility to the second facility.

11.-12. (canceled)
